(19) United States
(12) Patent Application Publication
(10) Pub. No.: US 2008/0063184 A1
(43) Pub. Date: Mar. 13, 2008

(54) Method of Performing a Modular Multiplication and Method of Performing a Euclidean Multiplication Using Numbers with 2N Bits

(76) Inventors: Pascal Paillier, Paris (FR); Marc Joye, Saint Zacharie (FR); Benoit Chevallier-Mames, Cassis (FR)

Correspondence Address: BUCHANAN, INGERSOLL & ROONEY PC, POST OFFICE BOX 1404, ALEXANDRIA, VA, 22313-1404, US

(21) Appl. No.: 10/568,749

(22) PCT Filed: Aug. 20, 2004
(86) PCT No.: PCT/FR04/50387

§ 371 Date: Nov. 1, 2007

(30) Foreign Application Priority Data
Aug. 21, 2003 (FR) 0310060

(51) Int. Cl. G06F 7/72; H04L 9/28

(52) U.S. Cl. 380/28; 708/491

(57) ABSTRACT

The invention relates to method of performing a modular multiplication using numbers with 2n bits. The method includes the steps of breaking the numbers (A, B) down into a 2ⁿ base or a U base, U being a suitable integer; and, subsequently, performing MultModDiv—and/or MultModDivlnit-type elementary operations on the numbers with n bits resulting from the first step. The invention also relates to a method of calculating a Euclidean multiplication/division. The invention can be used for cryptographic calculations.

The invention relates to a method of performing a modular multiplication of type A×B mod N using numbers A, B, N of 2×n bits with a processor able to work with numbers of n bits. The invention also relates to a method of performing an operation of type (X×Y)/Z using numbers X, Y, Z of n bits, suitable for implementing the method of performing a modular multiplication according to the invention. The invention is particularly useful for performing operations on large numbers (for example n of around 2048 bits) , which are used for example to carry out cryptographic calculations.

Considerable problems are encountered in performing modular arithmetic operations on numbers having a size greater than n, and this usually involves the use of complex algorithms such as, for example, the methods of Montgomery, Barrett, Quisquater or Walter, during which the large numbers are cut into words of n bits and then elementary operations are performed on the words of n bits.

However, such algorithms cannot be carried out using modular arithmetic processors which are limited, from the equipment point of view, to processing numbers of at most n bits. For example, a simple multiplication of two numbers of n bits cannot be carried out on some processors, for the simple reason that the result of the multiplication is a number of 2xn which cannot be processed by said processors.

It is therefore necessary to emulate this equipment, from the software point of view, so as to be able to perform operations on large numbers. To this end, Fisher and Seifert recently proposed in D1 (Increasing the Bitlength of a Crypto-processor, Wieland FISHER and Jean Pierre SEIFERT, CHES 2002, LNCS 2523, pp. 71-81, Springer-Verlag Berlin Heidelberg 2003) two solutions which make it possible to perform modular multiplications of type AxB mod N on numbers A, B, N of size 2×n (n being the size of the words processed by the processor employed) based on two elementary functions working on numbers of n bits.

The two elementary functions MultModDiv and MultModDivInit are defined by:

$$\begin{matrix}MultModDiv ( X , Y , Z ) = ( {Q}_{a} , {R}_{a} ) \\ = ( ⌊ ( X \times Y ) / Z ⌋ , ( X \times Y ) mod Z ) \\ MultModDivInit ( X , Y , T , Z ) = ( {Q}_{b} , {R}_{b} ) \\ = \begin{matrix}( ⌊ ( X \times Y + T \times {2}^{n} ) / Z ⌋ , \\ ( X \times Y + T \times {2}^{n} ) mod Z )\end{matrix}\end{matrix}$$

X, Y, T, Z are integers of at most n bits, X, Y, T are positive or negative, Z is positive, Qₐ, Q_{b}, Rₐ, R_{b} are results of n bits. Each MultModDiv and MultModDivInit operation performs inter alia two multiplications on numbers of n bits.

The notation “└A┘” denotes “integer part of A” (in other words, A is rounded down to the nearest integer). The notation “mod” is the usual abbreviation for “modulo”. The notation “×” is used to denote Euclidean multiplication.

Each MultModDiv or MultModDivInit function thus performs in practice two elementary operations on numbers X, Y, Z of n bits: one Euclidean multiplication (Q=└(X×Y)/Z┘ or └(X×Y+T×2ⁿ)/Z┘), the result of which is rounded to its integer value by default, and one modular multiplication (R=(X×Y) mod Z) or (X×Y+T×2ⁿ) mod Z).

It can rapidly be deduced from the definition of the function (Q, R)=MultModDiv(X, Y, Z) that:

X×Y=Q×Z+R

Similarly, it can be deduced from the definition of the function (Q, R)=MultModDiv(X, Y, Z, T) that:

X×Y+T×2ⁿ=Q×Z+R

These functions, and more generally all the arithmetic operations necessary for implementing the methods discussed below, are carried out in a modular arithmetic processor, dimensioned to work on numbers of at most n bits and to produce numbers of at most n bits.

Here and in the text which follows, for the sake of clarity, the same name will be used to denote both a register of the processor and the word or number of n bits that it contains. For instance, “C=A×B” means specifically in terms of the method “multiply the content of register A by the content of register B in a multiplication circuit, and store the result of the multiplication in register C”.

To perform the operation A×B mod N, where A, B, N are numbers of 2n bits, the solutions proposed by Fisher and Seifert break down the numbers A, B, N into two words of n bits, one word of high weight A₁, B₁, N₁, and one word of low weight A₀, B₀, N₀.

The first solution uses 7 MultModDiv functions, and can be summarized by the following algorithm FS1 (Fisher and Seifert's modular multiplication algorithm, 1st version):

Input: A, B, N, integers of 2n bits, broken down in the form:

A=A₁×2ⁿ+A₀; B=B₁×2ⁿ+B₀; N=N₁×2ⁿ+N₀;

Output: A×B mod N

Perform:

(Q₁, R₁)=MultModDiv(B₁, 2ⁿ, N₁)

(Q2, R₂)=MultModDiv(Q₁, N₀, 2ⁿ)

(Q3, R₃)=MultModDiv(A₁, R₁−Q₂+B₀, N₁)

(Q4, R₄)=MultModDiv(A₀, B₁, N₁)

(Q5, R₅)=MultModDiv(Q₃+Q₄, N₀, 2ⁿ)

(Q6, R₆)=MultModDiv(A₁, R₂, 2ⁿ)

(Q7, R₇)=MultModDiv(A₀, B₀, 2ⁿ)

Return (R₃+R₄−Q₅−Q₆+Q₇)×2ⁿ+(R₇−R₆−R₅) R₁ to R₇, Q₁ to Q₇ are intermediate variables of n bits which are required to obtain the final result.

The second solution proposed by Fisher and Seifert uses five functions of MultModDiv type and one MultModDivInit function. This second solution can be ummarized by the following algorithm FS2 (Fisher and Seifert's modular multiplication algorithm, 2nd version):

Input: A, B, N, integers of 2n bits, broken down in the form:

A=A₁×2ⁿ+A₀; B=B₁×2ⁿ+B₀; N=N₁×2ⁿ+N₀;

Output: A×B mod N

Perform:

(Q₁, R₁)=MultModDiv(A₁, B₁, N₁)

(Q₂, R₂)=MultModDivInit(N₀, −Q₁, R₁, N₁)

(Q₃, R₃)=MultModDiv(A₁, B₀, N₁)

(Q₄, R₄)=MultModDiv(A₀, B₁, N₁)

(Q₅, R₅)=MultModDiv(A₀, B₀, 2ⁿ)

(Q₆, R₆)=MultModDiv(Q₂+Q₃+Q₄, N₀, 2ⁿ)

Return (R₂+R₃+R₄+Q₅-Q₆)×2ⁿ+(R₅-R₆)

Details and additional information regarding the modes of implementing the two solutions proposed by Fisher and Seifert are proposed in D1.

As mentioned above, these two solutions make it possible to perform modular operations on numbers of at most 2×n bits using a processor which is intrinsically limited to numbers of n bits. However, these two solutions consume a lot of power since each MultModDiv or MultModDivInit function requires a certain number of elementary operations (additions, subtractions of register contents, shifting of bits in a register, etc.).

It should be noted that the implementation of a MultModDivInit function usually requires a greater number of elementary operations than the implementation of a MultModDiv function. (See in particular D1 for examples of implementation of MultModDiv and MultModDivInit functions). At best, with some processors, the implementation of the MultModDivInit operation is as costly as the MultModDiv operation (see, for example, Sedlak's algorithm).

The implementation of functions of the MultModDiv or MultModDivInit type requires the performance of elementary operations of type Q=└(X×Y)/Z┘ and R=(X×Y) mod Z, on numbers of n bits. Processors dedicated to cryptographic calculations usually have integrated hardware means for calculating modular operations of the type R=(X×Y) mod Z, but not always hardware means for performing Euclidean operations of the type Q=└(X×Y)/Z┘. In this case, use is usually made of emulating means (software) to perform the Euclidean operations on the basis of set of modular elementary operations.

For example, D1 describes a method which makes it possible to calculate Q=└(X×Y)/Z┘ based on operations of the type R₁=(X×Y) mod Z and R₂=(X×Y) mod (Z+1). More specifically, in D1, Q is calculated by the following relation:

Q=((X*Y) mod Z)−((X*Y) mod (Z+1) if this value is positive, or

Q=((X*Y) mod Z)−((X*Y) mod (Z+1))+(Z+1)

The operation R=(X×Y) mod Z is performed using the Montgomery algorithm, which is well known. However, although this algorithm is particularly effective (in terms of accuracy and calculation time) when the modulo Z is an odd integer, this is not the case when Z is an even integer. This means that the method proposed in D1 is not effective since one or the other of the numbers Z and Z+1 is necessarily even.

One object of the invention is to perform the same operations (A×B mod N, with A, B, N of 2×n bits) as the algorithms proposed by Fisher and Seifert, but by using a smaller number of elementary functions of the MultModDiv or MultModDivInit type, so as to provide a faster result while consuming less power.

Another object of the invention is a method of performing an operation of the type S=└(X×Y)/Z┘ on numbers of n bits which is more effective than the method proposed in D1. The method according to the invention can be used to perform a modular multiplication according to the invention.

The invention thus relates to a method of performing a modular multiplication of type A×B mod N, A, B, N being numbers of 2×n bits. Regardless of the mode of implementation of a method according to the invention, the numbers A, B, N are broken down into words of n bits. Then, during the method, operations are performed on the numbers A₁, A₀, B₁, B₀, N₁ and N₀ of n bits.

According to a first embodiment of the invention, the numbers A, B, N are broken down into a base 2ⁿ in the form: A=A₁×2ⁿ+A₀, B=B₁×2ⁿ+B₀ and N=N₁*2ⁿ+N₀. In other words, the n bits of high weight of A, B, N respectively form the word A₁, B₁, N₁, respectively, and the n bits of low weight of A, B, N respectively form the word A₀, B₀, N₀, respectively. Six elementary functions of MultModDiv type are then performed, the sixth providing the result of the modular multiplication.

Specifically, the following method A1 is carried out:

Input: A, B, N, integers of 2×n bits,

broken down in the form

A=A₁×2ⁿ+A₀; B=B₁×2ⁿ+B₀; N=N_{1×}2ⁿ+N₀;

Output: A×B mod N

Perform:

(Q₁, R₁)=MultModDiv(A₁, B₁, N₁)

(Q₂, R₂)=MultModDiv(Q₁, N₀, 2ⁿ)

(Q₃, R₃)=MultModDiv(A₁+A₀, B₁+B₀, 2ⁿ−1)

(Q₄, R₄)=MultModDiv(A₀, B₀, 2ⁿ)

(Q₅, R₅)=MultModDiv(2−1, R₁+Q₃−Q₂−Q₄, N₁)

(Q₆, R₆)=MultModDiv(Q₅, N₀, 2ⁿ)

Return (R₃+R₅−Q₆−R₂−R₄)×2ⁿ+(R₂+R₄−R₆)

The above algorithm A1 indeed performs the modular multiplication A×B mod N. According to Karatsuba's lemma (see in particular D2: “Multiplication Of Multidigit Numbers On Automata” Soviet Physics—Doklady, volume 7, pages 595-596, 1963), we have:

A×B=2ⁿ(2−1)A₁×B₁+2ⁿ(A₁+A₀)×(B₁+B₀)−(2ⁿ−1)A₀×B₀

Since N=N₁×₂ⁿ+N₀, we have N₁×2ⁿ η_{N} −N₀, where η_{N} is the equivalence relation modulo N.

From the definition of Q₁ to Q₆, R₁ to R₆ in algorithm A1 and from the definition of the MultModDiv function, it can be deduced that:

2ⁿ(2ⁿ−1)×A₁×B₁η_{N}2ⁿ(2ⁿ−1)(Q₁×N₁×R₁)

η_{N}−(2ⁿ−1)×(Q₁×N₀)+2ⁿ(2ⁿ−1)>R₁

η_{N}−(2ⁿ−1)(Q₂×2ⁿ+R₂)+2ⁿ(2ⁿ−1)R₁

η_{N}2ⁿ(2ⁿ−1)(R₁−Q₂)−(2ⁿ−1)×R₂

2ⁿ(A₁+A₀)(B₁+B₀)=2ⁿ((2ⁿ−1)Q₃+R₃)=2ⁿ(2ⁿ−1)Q₃+2ⁿ×R3

(2ⁿ−1)×A₀×B₀=(2ⁿ−1)(2ⁿ×Q₄+R₄)=2ⁿ(2ⁿ−1)Q₄+(2ⁿ−1)R⁴

The following is finally deduced therefrom:

A×Bη_{N}2ⁿ(2ⁿ−1)(R₁+Q₃−Q₂−Q₄)+2ⁿ×R₃−(2ⁿ−1)(R₂+R₄)

η_{N}2ⁿ(Q₅×N₁+R₅)+2ⁿ×R₃−(2ⁿ−1)(R₂+R₄)

η_{N}−Q₅×N₀+2ⁿ(R₃+R₅)−(2ⁿ−1)(R₂+R₄)

η_{N}−(Q⁶×2ⁿ+R₆)+2ⁿ(R₃+R₅)−(2ⁿ−1)(R₂+R₄)

η_{N}2ⁿ(R₃+R₅−Q₆−R₂−R₄)+(R₂+R₄−R₆)

and thus:

A×B mod N=2ⁿ(R₃+R₅−Q₆−R₂−R₄)+(R₂+R₄-R₆) which is the result produced by the algorithm A1.

It will be noted that the method A1 according to the invention uses one MultModDiv function less than the method FS1 known from the prior art. Thus, for the same result, there is a reduction in the total number of operations to be performed and consequently a reduction in total time and in the overall power consumed for executing the method. Specifically, since one MultModDiv operation performs 2 modular multiplications on numbers of n bits, the algorithm A1 in this case uses 12 modular multiplications on numbers of n bits instead of 14 in the algorithm FS1, hence a gain in calculation time of (14−12)/14=14%.

According to a second embodiment of the invention, the numbers A, B, N are likewise broken down into a base 2ⁿ in the form: A=A1×2ⁿ+A₀, B=B₁×2ⁿ+B₀ and N=N₁*2ⁿ+N₀. One function of MultModDivInit type and four elementary functions of MultModDiv type are then carried out, the fourth providing the result of the modular multiplication.

Specifically, the following method A2 is carried out:

Input: A, B, N, integers of 2×n bits, broken down in the form

A=A₁×2ⁿA₀; B=B₁×2ⁿ+B₀; N=N₁×2ⁿ+N₀;

Output: A×B mod N

Perform:

(Q₁,R₁)=MultModDiv(A₁,B₁,N₁)

(Q₂,R₂)=MultModDiv(A₁+A₀,B₁+B₀,2ⁿ−1)

(Q₃,R₃)=MultModDiv(A₀,B₀,2ⁿ)

(Q₄,R₄)=MultModDivInit(Q₁,N₀,Q₃−R₁−Q₂,N₁)

(Q₅,R₅)=MultModDiv(N₀+N₁,Q₄,2ⁿ)

Return (R₂+Q₅−R₃−R₄)×2ⁿ+(R₃+R₄+R₅)

The algorithm A1 indeed performs the modular multiplication A×B mod N. From the definitions of Q₁ to Q₅, R₁, to R₅, we have:

2ⁿ(2ⁿ−1)×A₁×B₁η_{N}2ⁿ(2ⁿ−1)Q₁×N₁+R₁)

(2ⁿ−1)(−Q₁×N₀+R₁×2ⁿ)

2ⁿ(A₁+A₀)(B₁+B₀)=2ⁿ((2ⁿ−1)Q₂+R₂)=2ⁿ(2ⁿ−1)Q₂+2ⁿ×R₂

(2ⁿ−1)A₀×B₀=(2ⁿ−1)(2ⁿ×Q₃+R₃)=2ⁿ(2ⁿ−1)Q₃+(2ⁿ−1)×R³

From Karatsuba's lemma (D2), we have:

A×B=2ⁿ(2ⁿ−1)A₁×B₁+2ⁿ(A₁+A₀)×(B₁+B₀)−(2ⁿ−1)A₀×B₀

The following is thus deduced therefrom (since N₁(2ⁿ−1) η_{N}−N₀−N₁):

A×Bη_{N}−(2ⁿ−1)(Q₁×N₀+(Q₃−R₁−Q₂)×2ⁿ)+2ⁿ×R₂−(2ⁿ−1)R₃

(2ⁿ−1)(Q₄×N₁+R₄)+2ⁿ×R₂−(2ⁿ−1)R₃

(N₀−N₁)Q₄+2ⁿ×R₂−(2ⁿ−1)(R₃+R₄)

(2ⁿ×Q₅+R₅)+2ⁿ×R₂−(2ⁿ−1)(R₃+R₄)

2ⁿ(R₂+Q₅−R₃−R₄)+(R₃+R₄+R₅)

and finally:

A×B mod N=2ⁿ(R₂+Q₅−R₃−R₄)+(R₃+R₄+R₅)

which is the result produced by the algorithm A2.

It will be noted that the method A2 according to the invention uses one MultModDiv function less than the method FS2 known from the prior art. Thus, in this case too, for the same result, there is a reduction in the total number of operations to be performed and consequently a reduction in total time and in the overall power consumed for executing the method. Specifically, since one MultModDiv operation or one MultModDivInit operation performs 2 modular multiplications on numbers of n bits, the algorithm A2 in this case uses 10 modular multiplications on numbers of n bits instead of 12 in the algorithm FS2, hence a gain in calculation time of (12−10)/12=16% compared to the equivalent method FS2 of D1.

According to a third embodiment of the invention, the numbers A, B, N are broken down into a base U, U being other than 2ⁿ, such that: A=A₁×U+A₀, B=B₁×U+B₀ and N=N₁×U+N₀. A₁, A₀, B₁, B₀, N₁ and N₀ are words of n bits. Elementary operations of MultModDiv type are then carried out on the words A₁, A₀, B₁, B₀, N₁ and N₀.

In a first example, the following method A3 is carried out:

Input: A, B, N, integers of 2×n bits, broken down in the form

A=A₁×U+A₀; B=B₁×U+B₀; N=N₁×U+N₀;

Output: A×B mod N

Perform:

(Q₁, R₁)=MultModDiv(A₀ B₀ U)

(Q₂, R₂)=MultModDiv(A₁+A₀, B₁+B₀, U)

(Q₃, R₃)=MultModDiv(A₁, B₁, U)

(Q₄, R₄)=MultModDiv(α, Q₃, U)

(Q₅, R₅)=MultModDiv(α, −Q₁+Q₂−Q₃+Q₄+R₃, U)

Return (R₅+R₁)+(R₄−R,+Q,+R₂−R₃+Q₅)×U

where α=U² mod N.

In this first example, the algorithm A3 indeed performs the modular multiplication A×B mod N. Since α=U² mod N, we have U² η_{N} α. Moreover, from the definitions of Q₁ to Q₅, R₁ to R₅, we have:

(U−1)×A₀×B₀η_{N}(U−1)(Q₁×U+R₁)

η_{N}Q₁×α−R₁+(R₁−Q₁)×U

U×(A₁+A₀)(B₁+B₀)η_{N}U(Q₂×U+R₂)

η_{N}Q₂×α+R₂×U

U(U−1)×A₁×B₁η_{N}U²×A₁×B₁−U×A₁×B₁

η_{N}U×(R₃×U+Q₃×α)−U×(Q₃×U+R₃)

η_{N}R₃×α+Q₃×α×U−Q₃×α+R₃×U

η_{N}(−Q₃R₃)×α+(−R₃+Q₃×α)×U

From Karatsuba's lemma (D2), we obtain:

A×B=U(U−1)A₁×B₁+U×(A₁+A₀)×(B₁+B₀)−(U−1)A₀×B₀,

i.e.:

A×Bη_{N}(−Q₃+R₃)×α+(−R₃+Q₃×α)×U +Q₂×α+R₂×U−Q₁×α+R₁−(R₁−Q₁)×U

η_{N}α(−Q₁+Q₂−Q₃+R₃)+R₁+U(−R₁+Q₁+R₂−R₃+Q₃×α)

η_{N}α(−Q₁+Q₂−Q₃+Q₄+R₃)+R₁+U(R₄−R₁+Q₁+R₂−R₃)

η_{N}(R₅+R₁)+U(R₄−R₁+Q₁+R₂−R₃+Q₅)

which is the result produced by algorithm A3.

It will be noted that, in this first example, the method A3 according to the invention uses an even smaller number of MultModDiv functions than the known methods or even than the first embodiment or the second embodiment of the invention. We thus again have, for the same result, an even greater reduction in the total number of operations to be performed and consequently a reduction in total time and in the overall power consumed for executing the method. Specifically, since one MultModDiv operation or one MultModDivInit operation performs 2 modular multiplications on numbers of n bits, the algorithm A3 in this case uses 10 modular multiplications on numbers of n bits instead of 14 in the algorithm FS1, hence a gain in calculation time of (14−10)/14=28% compared to the equivalent method FS1 of D1.

In order to carry out this first example, it would be possible for example to select U=┌√N┐, where √N is the square root of N and ┌√N┐ is the rounded-up integer part of √N (in other words, U is the rounded integer immediately greater than EN). It would also be possible to select U=┌√(k.N)┐, where k is an integer. Preferably, k is selected such that α=U² mod N is as small as possible.

In a second example, U is defined by the relation: U² η_{N} α+δ×U. α and δ are integers which are preferably constant and as small as possible (less than 256 bits). α and δ are preferably selected such that α+δ² is also a constant and small integer.

Ideally, δ=1 and α=−1, 2 or 3. Such values α, δ can be obtained by selecting a suitable number N, that is to say by selecting a suitable key generation method (it will be recalled that N here is an element of a key for a cryptographic algorithm).

The method A3 can be simplified to give the following method A4:

Input: A, B, N, integers of 2n bits, broken down in the form

A=A₁×U+A₀; B=B₁×U+B₀; N=N₁×U+N₀;

Output: A×B mod N

Perform:

(Q₁,R₁)=MultModDiv(A₀,B₀,U)

(Q₂,R₂)=MultModDiv(A₁,+A₀,B₁+B₀,U)

(Q₃,R₃)=MultModDiv(A₁,B₁,U)

Return α×(−Q₁+Q₂−Q₃+R₃+δ×Q₃)+R₁+U×[(−R₁−R₃+Q₁+R₂+Q₃(α+δ²)+(−Q₃+R₃−Q₁+Q₂)×δ]

The algorithm A4 indeed performs the modular multiplication A×B mod N. By using U² η_{N} α+δ×U and Karatsuba's lemma, we obtain:

(U−1)×A₀×B₀η_{N}(U−1)(Q₁×U+R₁)

η_{N}−Q₁×U−R₁+R₁×U+Q₁(α+δ×U)

η_{N}Q₁×α−R₁+(R₁−Q₁+Q₁×δ)×U

U×(A₁+A₀)(B₁+B₀)η_{N}U(Q₂×U+R₂)

η_{N}R₂×U+Q₂×(α+δU)

η_{N}α×Q₂+(R₂+δ×Q₂)U

U×A₁×B, η_{N}U(Q₃×U+R₃)η_{N}αQ₃+(R₃+δ×Q₃)U

U²×A₁×B₁η_{N}U(α×Q₃+(R₃+δ×Q₃)×U)

η_{N}α×U×Q₃+(R₃+δ×Q₃)×(α+δ×U)

η_{N}α×(R₃+δ×Q₃)+((δ×(R₃+δ×Q₃)+α×Q₃)×U

U(U−1)×A₁×B₁η_{N}α×(R₃−Q₃+(δ×Q₃)+((R₃+δ×Q₃)×(δ−1)+α×Q₃)×U

η_{N}α×(R₃−Q₃+δ×Q₃)+[−R₃+δ×(−Q₃+R₃)+Q₃×(δ²+α)]×U

and thus:

A×Bη_{N}α×(−Q₁+Q₂−Q₃+R₃+δ×Q₃)+R₁+U×(−R₁−R₃+Q₁+R₂+Q₃×(α+δ²)+δ×(−Q₃+R₃−Q₁+Q₂)

It will be noted that the method A4 according to the invention uses an even smaller number of MultModDiv functions than the known methods or even than the first embodiment or the second embodiment of the invention. We thus again have, for the same result, an even greater reduction in the total number of operations to be performed and consequently a reduction in total time and in the overall power consumed for executing the method.

In a third example, the following method A5 is carried out:

Input: A, B, N, integers of 2n bits,

broken down in the form

A=A₁×U+A₀; B=B₁×U+B₀; N=N₁×U+N₀;

Output: A×B mod N

Perform:

(X1, Y1, Z1, R1)=Coefficients(A, B, U)

(Q₂, R₂)=MultModDiv(α, X₁, U)

(Q₃, R₃)=MultModDiv(α, Y₁+Q₂, U)

Return R₁+R₃+(R₂+Z₁+Q₃)×U

The Coefficient function calculates in a base U the coefficients of the polynomial produced from two integers A, B broken down into the base U (A₁×X+A₀ and B=B₁×X+B₀):

Coefficients (A, B, U)=(C₃, C₂, C₁, C₀) such that

C3=f; C2=d+3f; C1=e+2f; C0=R0; where:

R₀=(A mod U) (Bmod U) mod U

R₁=(A mod(U+1))(Bmod(U+1))mod(U+1)

R₂=(A mod(U+2))(Bmod(U+2))mod(U+2)

R₃=(A mod(2U+3))(Bmod(2U+3))mod(2U+3)

and

a=(R0−R2+((R0−R2) mod 2)(U+2))/2 mod U+2

b=R0−R1 mod (U+1)

c=(2(R0−R3)+(2(R0−R3) mod 3)(2U+3))/3 mod (2U+3)

d=((b−a) mod (U+1))

e=a+2d

f=−6d+4e−4c mod (2U+3)

C₃, C₂, C₁, C₀ verify A×B=C₃×U³+C₂×U²+C₁×U+C₀

It should be noted that, since A=A₁>U+A₀ and B=B₁>U+B₀, R₀, R₁, R₂, R₃ can easily be calculated from the following relations:

R₀=A₀B₀ mod U

R₁=(A₀−A₁) (B₉−B₁) mod (U+1)

R₂=(A₀−2A₁) (B₀−2B₁) mod (U+2)

R₃=(A₀+(A₁ mod 2)U−3(A₁ div 2))×(B₀+(B₁ mod 2)U−3 (B₁ div 2)) mod (2U+3)

As above, the cost, in terms of calculation time, of the auxiliary operations such as additions, subtractions, etc. is negligible.

The algorithm A5 indeed performs the modular multiplication A×B mod N. By using the definition of the Coefficients function, we have:

A×B=X₁×U³+Y₁×U²+Z₁×U+R₁

η_{N}R₁+α×Y₁+(α×X₁+Z₁)×U

η_{N}R₁+α×Y₁+(Q₂×U+R₂+Z₁)×U

η_{N}R₁+α×(Y₁+Q₂)+(R₂+Z₁)×U

η_{N}R₁+R₃+(R₂+Z₁+Q₃)×U

In this third example, it would be possible to select U=┌√N┐. It would also be possible to select U=┌√(k.N)┐ where k is an integer.

k is preferably selected to be as small as possible such that U is odd and cannot be divided by three. To this end, for example, a number of increasing values of k will be tested until a satisfactory value of U is obtained. It would also be possible to select k to be as small as possible such that U is odd and cannot be divided by three and such that α=U² mod N is as small as possible.

Finally, the invention relates to a method of performing an operation of type S=└(X×Y)/Z┘, where X, Y, Z are numbers of n bits. This method can be used to perform a modular multiplication as described above and more generally a MultModDiv function. During the method, the following steps are carried out:

E1: a variable Δ↑ is initialized to zero and two data items are calculated:

C=X×Y mod Z and Cβ=X×Y mod (Z+β), β being a predefined positive integer of n bits.

E2: the result S=[C−Cβ−Δβ(Z+β)]/β is calculated.

E3: if the intermediate data item is not an integer, the variable Δβ is incremented by 1 and step E2 and then step E3 are repeated.

To justify the method as described above, the following text will demonstrate firstly that an integer Δβ exists such that S=└XY/Z┘=[C−Cβ−Δβ(Z+β)]/β. It will then be shown that the above method makes it possible to find the correct value of Δβ and S.

Let β be a positive integer of n bits. We define:

C=X×Y mod Z

Cβ=X×Y mod (Z+β)

Δβ=└XY/Z┘−└XY/(Z+β)┘

Δβ verifies: 0≦Δβ≦β. In fact, since Z<Z+β, we have XY/(Z+β)<XY/Z and we deduce therefrom that └XY/(Z+β)┘<└XY/Z┘. Furthermore:

XY/Z=[XY/(Z+β)]×(1+β/Z)≦XY/(Z+β)+[(Z−1)²/((Z+β)Z)]<XY/(Z+β)+β

Since β is an integer, ┌β┐=β and hence:

└XY/Z┘≦└XY/(Z+β)┘+┌β┐=└XY/(Z+β)┘+β

These last two inequalities allow us to conclude that └XY/(Z+β)┘≦└XY/Z┘≦└XY/(Z+β)┘+β, i.e.:

0≦Δβ≦β

Then, by definition of C and Cβ:

$$\begin{matrix}XY = ⌊ XY / Z ⌋ \times Z + C \\ = ⌊ XY / ( Z + β ) ⌋ \times ( Z + β ) + C β \\ = ( Δ β + ⌊ XY / Z ⌋ ) \times ( Z + β ) + C β\end{matrix}$$

i.e. C=└XY/Z┘×β+Δβ×(Z+β)+Cβ and hence:

└XY/Z┘=[C−Cβ−Δβ×(Z+β)]/β

(calculation of step E3 of the method)

From the last relation, it can be deduced that └XY/Z┘ is equal to (C−Cβ)/β less a corrective term Δβ(Z+β)/β. Furthermore, by definition, └XY/Z┘ is an integer, as are β and Δβ. Thus, by calculating=[C−Cβ−Δβ×(Z+β)]/β systematically using the various possible values of Δβ, and by verifying whether the result is an integer, the correct value of β is calculated and thus the correct value of └XY/Z┘.

As shown above, 0≦Δβ≦β. Thus, by selecting a small parameter β, there are a limited number of possible values for Δβ and thus a limited number of attempts necessary to obtain the correct value of └XY/Z┘.

Experience shows that the best results (in terms of calculation speed in particular) are obtained for values of b selected to be equal to a power of 2, among which values β=2 give the best results. This is because, with β=2, modular reductions (C=X×Y mod Z and Cβ=X×Y mod (Z+β)) are carried out only with moduli (Z and Z+2) having the same parity as Z and thus any difficulty associated with calculating a modular multiplication using an even modulo is avoided. Furthermore, division by β=2 is not costly in terms of calculation time, since such an operation in practice comes down to shifting the content of a register one bit to the right. Finally, at most two values of Δβ have to be tested (0 and 1).

1. Cryptographic method of performing a modular multiplication of type A×B mod N, during which method:
if they are not given in broken down form, the numbers A, B, N of 2×n bits are broken down into a base U such that A=A₁×U+A₀, B=B₁×U+B₀ and N=N₁×U+N₀, A₁, A₀, B₁, B₀, N₁ and N₀ being words of n bits, then
operations of MultModDiv type are performed on the numbers A₁, A₀, B₁, B₀, N₁ and N₀, the MultModDiv elementary operation being defined by MultModDiv(X, Y, Z)=(└(X×Y)/Z┘, (X×Y) mod Z), X, Y, Z being integers of at most n bits.

2. Method according to claim 1, in which U is other than 2ⁿ.

3. Method according to claim 2, during which:
the following operations are performed:
(Q₁, R₁)=MultModDiv(A₀, B₀, U)
(Q₂, R₂)=MultModDiv(A₁+A₀, B₁+B₀, U)
(Q₃, R₃)=MultModDiv(A₁, B₁, U)
(Q₄, R₄)=MultModDiv(α, Q₃, U)
(Q₅, R₅)=MultModDiv(α, −Q₁+Q₂−Q₃+Q₄+R₃, U)
R₁ to R₅, Q₁ to Q₅ being intermediate results of n bits, a being defined by the relation: α=U² mod N, then
the following result is returned:
(R₅+R₁)+(R₄−R₁+Q₁+R₂−R₃+Q₅)×U

4. Method according to claim 3, during which the number U is selected to be equal to ┌√N┌.

5. Method according to claim 3, during which the number U is selected to be equal to ┌√(k.N)┐, k being an integer.

6. Method according to claim 5, during which the number k is selected such that a is as small as possible.

7. Method according to claim 2, during which:
the number U is initially calculated in accordance with the relation U² η_{N} α+δ×U, α and δ being integers, then
the following operations are performed:
(Q₁, R₁)=MultModDiv(A₀, B₀, U)
(Q₂, R₂)=MultModDiv(A₁+A₀, B₁+B₀, U)
(Q₃, R₃)=MultModDiv(A₁, B₁, U)
R₁ to R₅, Q₁ to Q₅ being intermediate results of n bits, then
the following result is returned:
α×(−Q₁+Q₂−Q₃+R₃δ×Q₃)+R₁+U×[(−R₁−R₃+Q₁+R₂+Q₃(α+δ²)+(−Q₃+R₃−Q₁+Q₂)×δ]

8. Method according to claim 7, in which the numbers α and δ are selected to be constant, as small as possible and such that α+δ² is also a constant and small integer.

9. Method according to claim 2, during which:
the following operations are performed:
(X1, Y1, Z1, R1)=Coefficients(A, B, U)
(Q₂, R₂)=MultModDiv(α, X₁, U)
(Q₃, R₃)=MultModDiv(α, Y₁+Q₂, U)
α being an integer defined by α=U² mod N, the Coefficient elementary operation being defined by Coefficients (A, B, U)=(C₃, C₂, C₁, C₀) such that
C3=f; C2=d+3f; C1=e+2f; C0=R0; where:
R₀=(A mod U)(Bmod U) mod U
R₁=(A mod(U+1))(Bmod(U+1))mod(U+1)
R₂=(A mod(U+2))(Bmod(U+2))mod(U+2)
R₃=(A mod(2U+3))(Bmod(2U+3))mod(2U+3)
and
a=(R0−R2+((R0−R2) mod 2)(U+2))/2 mod U+2
b=R0−R1 mod (U+1)
c=(2(R0−R3)+(2(R0−R3) mod 3)(2U+3))/3 mod (2U+3)
d=((b−a) mod (U+1))
e=a+2d
f=−6d+4e−4c mod (2U+3)
the following result is returned:
R₁+R₃+(R₂+Z₁+Q₃)×U

10. Method according to claim 2, during which:
the following operations are performed:
(X1, Y1, Z1, R1)=Coefficients(A, B, U)
(Q₂, R₂)=MultModDiv(α, X₁, U)
(Q₃, R₃)=MultModDiv(α, Y₁+Q₂, U)
α being an integer defined by α=U² mod N, the Coefficient elementary operation being defined by Coefficients (A, B, U)=(C₃, C₂, C₁, C₀) such that
C3=f; C2=d+3f; C1=e+2f; C0=R0; where:
R₀=A₀B₀ mod U
R₁=(A₀−A₁)(B₀−B₁) mod (U+1)
R₂=(A₀−2A₁)(B₀−2B₁) mod (U+2)
R₃=(A₀+(A₁ mod 2)U−3(A₁ div 2))×(B₀+(B₁ mod 2)U−3(B₁ div 2)) mod (2U+3)
and
a=(R0−R2+((R0−R2) mod 2)(U+2))/2 mod U+2
b=R0−R1 mod (U+1)
c=(2(R0−R3)+(2(R0−R3) mod 3)(2U+3))/3 mod (2U+3)
d=((b−a) mod (U+1))
e=a+2d
f=−6d+4e−4c mod (2U+3)
the following result is returned:
R₁+R₃+(R₂+Z₁+Q₃)×U

11. Method according to claim 9, during which the number U is selected to be equal to ┌√N┐.

12. Method according to claim 9, during which the number U is selected to be equal to ┌√(k.N)┐, k being an integer.

13. Method according to claim 12, in which k is selected to be as small as possible such that U is odd and cannot be divided by three.

14. Method according to claim 13, during which the number k is selected such that a is as small as possible.

15. Method according to claim 1, in which U is equal to 2ⁿ and during which:
the following operations are performed:
(Q₁, R₁)=MultModDiv(A₁, B₁, N₁)
(Q₂, R₂)=MultModDiv(Q₁, N₀, 2ⁿ)
(Q₃, R₃)=MultModDiv(A₁+A₀, B₁+B₀, 2ⁿ−1)
(Q₄, R₄)=MultModDiv(A₀, B₀, 2ⁿ)
(Q₅, R₅)=MultModDiv(2ⁿ−1, R₁+Q₃−Q₂−Q₄, N₁)
(Q₆, R₆)=MultModDiv(Q₅, N₀, 2ⁿ)
R₁ to R₆, Q₁ to Q₆ being intermediate results of n bits, the MultModDiv elementary operation being defined by MultModDiv(X, Y, Z)=(└(X×Y)/Z┘, (X×Y) mod Z), X, Y, Z being integers of at most n bits, then
the following result is returned:
(R₃+R₅−Q₆−R₂−R₄)×2ⁿ+(R₂+R₄−R₆)

16. Method according to claim 1, in which U is equal to 2ⁿ and during which:
the following operations are performed:
(Q₁, R₁)=MultModDiv(A₁, B₁, N₁)
(Q₂, R₂)=MultModDiv(A₁+A₀, B₁+B₀, 2ⁿ−1)
(Q₃, R₃)=MultModDiv(A₀, B₀, 2ⁿ)
(Q₄, R₄)=MultModDiv(Q₁, N₀, Q₃−R₁−Q₂, N₁)
(Q₅, R₅)=MultModDiv(N₀+N₁, Q₄, 2ⁿ)
R₁ to R₅, Q₁ to Q₅ being intermediate results of n bits, the MultModDiv elementary operation being defined by MultModDiv(X, Y, Z)=(└(X×Y)/z┘, (X×Y) mod Z), and the MultModDivlnit elementary operation being defined by MultModDivinit(X, Y, T, Z)=(└(X×Y+T×2ⁿ)/Z┘, (X×Y)+T×2ⁿ)mod Z), X, Y, Z and T being integers of at most n bits, then
the following result is returned:
(R₂+Q₅−R₃−R₄)×2ⁿ+(R₃+R₄+R₅)AUTONUMAUTONUM
